(19) United States
(12) Patent Application Publication
(10) Pub. No.: US 2013/0124193 A1
(43) Pub. Date: May 16, 2013

(54) System and Method Implementing a Text Analysis Service

(71) Applicant: Greg Holmberg, Lafayette, CA (US)

(72) Inventor: Greg Holmberg, Lafayette, CA (US)

(73) Assignee: BUSINESS OBJECTS SOFTWARE LIMITED, Dublin (IE)

(21) Appl. No.: 13/297,152

(22) Filed: Nov. 15, 2011

(51) Int. Cl. G06F 17/27

(52) U.S. Cl. 704/9; 704/E15.001

(57) ABSTRACT

One embodiment includes a computer implemented method of processing documents. The method includes generating a text analysis task object that includes instructions regarding a document processing pipeline and a document identifier. The method further includes accessing, by a worker system, the text analysis task object and generating the document processing pipeline according to the instructions. The method further includes performing text analysis using the document processing pipeline on a document identified by the document identifier.

### CROSS REFERENCE TO RELATED APPLICATIONS

The present application is related to U.S. application Ser. No. ______ for “System and Method Implementing a Text Analysis Repository”, attorney docket number 000005-017500US, filed on the same date as the present application, which is incorporated herein by reference.

### BACKGROUND

The present invention relates to data processing, and in particular, to data processing for text analysis applications.

Unless otherwise indicated herein, the approaches described in this section are not prior art to the claims in this application and are not admitted to be prior art by inclusion in this section.

Modern business applications do not only operate on internal well-structured data, but increasingly need to also incorporate external, typically less well-structured data from various sources. Traditional data warehousing or data mining approaches require resource intensive structuring, modeling and integration of the data before it can actually be uploaded into a consolidated data store for consumption. These upfront pre-processing and modeling steps make the consideration of data that is less well structured in many cases prohibitively expensive. As a result, only a fraction of the available business-relevant data is actually leveraged for business intelligence and decision support.

A number of tools exist for scaling up the throughput of text analysis, including the Inxight Processing Manager™ tool, the Inxight Text Services Platform™ tool, the Apache UIMA Asynchronous Scale-out™ tool, and the Hadoop™ tool.

The Inxight Processing Manager™ (PM) tool is a system with limited scalability. It can run a pipeline sequencing on one machine, and the discrete text analysis steps on another machine (the “IMS” server). The two communicate over the network using a proprietary XML-based protocol. Each processing step in the pipeline is a separate call to the IMS server.

The Inxight Text Services Platform™ (TSP) tool is a set of servers that wrap a SOAP (XML over HTTP) network interface around the text analysis libraries, with each library in a separate server. Functionally, the SOAP services are completely identical to the libraries they wrap, but provide some degree of scalability by processing multiple SOAP requests concurrently. Each text analysis function (language identification, entity extraction, etc.) is a separate request. An HTTP network load balancer may be inserted in front of the TSP servers to attempt to distribute the requests in a passive round-robin fashion.

The Inxight Text Services Platform™ tool has no provision for overall pipeline sequencing, however TSP may be integrated into PM as a replacement for IMS. This improves the scalability of PM somewhat.

The Apache UIMA Asynchronous Scale-out™ (UIMA-AS) tool uses a message queue system to distribute documents to be processed. It can be configured in many different scaling modes, but the most scalable mode is one that passes document URLs through the messaging system. A URL is transferred over the network as part of a message encoded in XML.

The famous IBM Watson question-answering system that beat the two best human players on the TV game-show “Jeopardy!” uses UIMA-AS. This system uses several thousand CPU cores (not all for text analysis though), so UIMA-AS scales pretty well, at least if one has three million dollars to spend on special IBM hardware.

The Hadoop™ tool, also referred to as Apache Hadoop™, is an open-source implementation of Google MapReduce in Java. (MapReduce is a software technique to support distributed computing on large data sets on clusters of computers.) Hadoop™ is not a document processing system specifically, but could be used to build a document processing system, i.e. as part of such a system. Hadoop™ can scale up many kinds of data processing, but it works best as an batch analytics engine over a large fixed set of small data (“big data”), such as is traditionally stored in a database. This is because a known set of small, equal-sized objects can be easily distributed evenly over a number of machines in pre-allocated sub-sets. Since the objects represent equal work, this results in a system with a balanced load. The load does not need to be re-balanced as the analysis runs. In a nutshell, Hadoop™ distributes data over a set of machines using a distributed file system, sub-operations work on different parts of the data on separate machines, and then the result data is brought together on other machines and assembled into a final answer. It is simple to set up, and it scales pretty well. An example implementation of Hadoop™ for text processing is the Behemoth project from DigitalPebble.

### SUMMARY

Embodiments of the present invention improve text analysis applications. SAP, through the acquisition of Business Objects, owns text analytics tools to analyze and mine text documents. These tools provide a platform to lower the cost for leveraging weakly structured data, such as text in business applications. Embodiments of the present invention may be referred to as the Text Analysis (TA) System, the TA Cluster, the TA Service (as implemented by the TA System), the Text Analysis Network Service, the TAS, the TAS software, or simply as “the system”.

In one embodiment the present invention includes a computer implemented method of processing documents. The method includes generating, by a controller system, a text analysis task object. The text analysis task object includes instructions regarding a document processing pipeline and a document identifier. The method further includes storing the text analysis task object in a task queue as one of a number of text analysis task objects. The method further includes accessing, by a worker system of a number of worker systems, the text analysis task object in the task queue. The method further includes generating, by the worker system, the document processing pipeline according to the instructions in the text analysis task object. The method further includes performing text analysis, by the worker system using the document processing pipeline, on a document identified by the document identifier. The method further includes outputting, by the worker system, a result of performing text analysis on the document.

The method may further include generating the text analysis task objects, storing the text analysis task objects in the task queue, and accessing the text analysis task objects according to a first-in, first-out priority.

The method may further include generating the text analysis task objects, storing the text analysis task objects in the task queue, receiving requests from at least some of the worker systems, and providing the text analysis task objects to the at least some of the worker systems according to a first-in, first-out priority.

Accessing the text analysis task object in the task queue may include accessing, by the worker system via a first network path, the text analysis task object in the task queue. The method may further include accessing, by the worker system via a second network path, the document identified by the document identifier.

Accessing the text analysis task object in the task queue may include accessing, by the worker system via a first network path, the text analysis task object in the task queue. The method may further include accessing, by the worker system via a second network path, the document identified by the document identifier. Outputting the result may include outputting, by the worker system via a third network path, the result of performing the text analysis on the document.

When the worker system encounters a failure when performing the text analysis and fails to output the result, the method may further include replacing, by the controller system, the text analysis task object in the task queue after a time out, and accessing, by another worker system, the text analysis task object having been replaced in the task queue.

The document processing pipeline may include a number of document processing plug-ins arranged in an order according to the instructions.

The method may further include performing text analysis, by the worker system using a first document processing plug-in, on the document to generate an intermediate result, and performing text analysis, by the worker system using a second document processing plug-in, on the intermediate result to generate the result of performing text analysis on the document.

The method may further include performing text analysis, by the worker system using a first document processing plug-in, on the document to generate an intermediate result, and performing text analysis, by the worker system using a second document processing plug-in as configured by the intermediate result, on the document to generate the result of performing text analysis on the document.

The method may further include performing text analysis, by the worker system using a first document processing plug-in, on the document to generate a first intermediate result and a second intermediate result, and performing text analysis, by the worker system using a second document processing plug-in as configured by the first intermediate result, on the second intermediate result to generate the result of performing text analysis on the document.

A system may implement the method described above. The system may include a controller system, a storage system, and a number of worker systems that are configured to perform various of the method steps described above.

A non-transitory computer readable medium may storing a computer program for controlling a document processing system. The computer program may include a first generating component, a storing component, an accessing component, a second generating component, a text analysis component, and an outputting component that are configured to control various components of the document processing system in a manner consistent with the method steps described above.

The following detailed description and accompanying drawings provide a better understanding of the nature and advantages of the present invention.

### BRIEF DESCRIPTION OF THE DRAWINGS

FIG. 1 is block diagram of a system for processing documents.

FIG. 2 shows an example of a text analysis cluster using a master-worker design pattern.

FIG. 3 is a block diagram showing further details of the text analysis cluster 104 (cf. FIG. 1).

FIG. 4 is a flow diagram of a method of processing documents.

FIG. 5 is a flowchart of an example process showing further details of the operation of the text analysis cluster 104 (see FIG. 3).

FIG. 6 is a block diagram showing further details of the text analysis cluster 104 (see FIG. 1) when it is executing a task as per 508 (see FIG. 5).

FIG. 7 is a block diagram of an example computer system and network for implementing embodiments of the present invention.

### DETAILED DESCRIPTION

Before describing the specifics of embodiments of the present invention, the embodiments are put into context by identifying the problems of existing solutions. The existing solutions discussed in the Background may have one or more of the following problems.

In the Inxight Processing Manager™ tool, at most two machines can be used. The proprietary XML-based format for communication is very inefficient with both network bandwidth and CPU. Having networking in the middle of the pipeline creates difficult bottlenecks. The document is passed over the network many times. PM could run a few times faster than a non-scalable system, but quickly hit throughput limits. There is no fault tolerance. If the IMS server fails, the system is unavailable until it is manually restarted. The PM tool does not have a configurable processing pipeline, and cannot serve multiple clients with needs for different processing.

In the Inxight Text Services Platform™ tool, when running TSP with PM, PM (as the overall pipeline sequencer) is still a bottleneck, as it can only run on one machine. This PM+TSP system had many of the same limitations as PM+IMS, but with a somewhat higher throughput ceiling.

When running TSP without PM, the application has to provide its own pipeline sequencing, with each step a separate call to a TSP server, creating a lot of network traffic. Further, the document content is embedded in the request, and the result data is embedded in the response, both of which therefore travel through the load balancer, creating a severe bottleneck. Further, it is very difficult to get all the TSP server machines to reach 100% CPU utilization. A human would have to manually re-allocate machines to different TSP functions (depending on the configuration of the requests and the types and sizes of the documents) in order to achieve even partial utilization of a set of hardware. Finally, the system is inefficient, and spends nearly half the CPU cycles just processing the SOAP XML messages.

In the Apache UIMA Asynchronous Scale-out™ tool, UIMA-AS can only use a single configuration at a time, so multiple clients are only possible if they happen to use the same configuration (which is unlikely). This single configuration is static. That is, the pipeline configuration has to be set up manually by shutting down the service, copying files to machines in the cluster, and restarting. In addition, if there are multiple clients, UIMA-AS provides no means to provide fairness or priorities. The clients compete to insert messages into the queue with no coordination. Finally, if a machine in the UIMA-AS cluster crashes, the documents being processed may be lost.

Hadoop™ is not particularly efficient. In benchmarking at Brown University, a “major SQL database vendor” (a row-store) was found to be 3.2 times faster than Hadoop™, and the commercial column-store Vertica was found to be 2.3 times faster than that, or more than 7 times faster than Hadoop™. They were impressed by how easy Hadoop™ was to set up and use, and praised its fault tolerance and extensibility. But it came at a large performance cost. They described Hadoop™ as “a brute force solution that wastes vast amounts of energy”.

At the root of the performance problem with Hadoop™ is the fact that it has to move large amounts of data around the cluster for the Map step, and then move the result data around to other machines for the Reduce step. It does this with its distributed file system, and the result is not only a lot of network I/O, but also a lot of disk I/O.

However, even more important is that MapReduce is not a good fit for text analysis, which of itself need require neither a Map step nor a Reduce step. All text analysis requires is to get the documents from their source (web server, mail server, file server, app server, etc.) to a machine where we can run a text analysis pipeline self-contained on that system, and then send the result data to a repository. So we have no need to store the data or move it to different machines during the analysis. Further, the data to be processed is not a static set, but is unknown in advance (it is discovered as it is crawled).

In addition, Hadoop™ combines the coordination information with the data to be processed (the documents, in the case of text analysis), and then proceeds to bounce that data around the cluster. In addition, the data first has to be pre-loaded into the file system from wherever it is normally stored. This loading process takes considerable time, and is not conducive to a continuous stream of data, as with an on-demand service to many concurrent clients.

These existing systems may have problems in one or more of the following areas: reliability, throughput, efficiency, and multi-client capacity. Regarding reliability, large memory usage and bugs in the text analysis code cause software systems that call this code to crash, never complete, or otherwise become unreliable or unavailable. Regarding throughput, some text analysis software, with all the options turned on and complex rule-sets installed, can run as slow as 9 MB/hour. Regarding efficiency, prior attempts to solve the throughput and reliability problems have resulted in inefficient use of computing power and network bandwidth, which resulted in high hardware costs for a desired level of throughput. Regarding multi-client capacity, prior systems required separate installations for each configuration of document processing, resulting in high hardware costs to serve a given set of application systems, and wasted capacity.

In summary, the existing systems such as that described in the Background may have one or more of the following problems. The existing system supports only a single configuration at a time. It supports multiple clients but does not ensure fair capacity sharing. It requires manual re-purposing of machines (e.g., different parts of the system scale at different rates, depending on documents and software configuration). It does not scale linearly to hundreds of CPUs (e.g., each additional CPU doesn't provide the same gain, whether it's the second one or the 100th). It leaves some CPUs under-utilized or idle. It does not scale efficiently. It becomes even less efficient as it reaches its capacity limit. It has a low throughput ceiling for a given compute and network hardware. It requires taking down the service to expand capacity. It can lose data. It cannot continue if the client fails.

Given the above problems, a goal of the TA Service is to reduce both the cost of consumption for development groups wanting to perform text analysis, and also to reduce the capital and operational costs of anyone (SAP or a customer) installing such an application.

Described herein are techniques for text analysis. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

In this document, various methods, processes and procedures are detailed. Although particular steps may be described in a certain order, such order is mainly for convenience and clarity. A particular step may be repeated more than once, may occur before or after other steps (even if those steps are otherwise described in another order), and may occur in parallel with other steps. A second step is required to follow a first step only when the first step must be completed before the second step is begun. Such a situation will be specifically pointed out when not clear from the context.

In this document, the terms “and”, “or” and “and/or” are used. Such terms are to be read as having the same meaning; that is, inclusively. For example, “A and B” may mean at least the following: “both A and B”, “only A”, “only B”, “at least both A and B”. As another example, “A or B” may mean at least the following: “only A”, “only B”, “both A and B”, “at least both A and B”. When an exclusive-or is intended, such will be specifically noted (e.g., “either A or B”, “at most one of A and B”).

In this document, the term “server” is used. In general, a server is a hardware device, and the descriptor “hardware” may be omitted in the discussion of a hardware server. A server may implement or execute a computer program that controls the functionality of the server. Such a computer program may also be referred to functionally as a server, or be described as implementing a server function; however, it is to be understood that the computer program implementing server functionality or controlling the hardware server is more precisely referred to as a “software server”, a “server component”, or a “server computer program”.

In this document, the term “database” is used. In general, a database is a data structure to organize, store, and retrieve large amounts of data easily. A database may also be referred to as a data store. The term database is generally used to refer to a relational database, in which data is stored in the form of tables and the relationship among the data is also stored in the form of tables. A database management system (DBMS) generally refers to a hardware computer system (e.g., persistent memory such as a disk drive, volatile memory such as random access memory, a processor, etc.) that implements a database.

In general, the term “application” refers to a computer program that solves a business problem and interacts with its users, typically on computer screens. Example applications include Customer Relationship Management (CRM) or Enterprise Resource Planning (ERP).

In general, the term “document” refers to data containing written or spoken natural language, e.g. as sentences and paragraphs. Examples are written documents, audio recordings, images, or video recordings. All forms can have the text of their natural language extracted from them for computer processing. Documents are sometimes also called “unstructured information”, in contrast to the structured information in database tables.

In general, the term “document processing” refers to reading a document to extract text, parse text, identify parts of text, transform text, or otherwise understand or manipulate the text or concepts therein. Often this processes each document independently, in memory, without persistent storage.

In general, the term “text analysis” refers to a kind of document processing that identifies or extracts linguistic constructs in text. For example, identifying the parts of speech (nouns, verbs, etc), or identifying entities (people, products, companies, countries, etc.). Text analysis may also extract key phrases or key sentences; classify a document into a taxonomy; or any other kind of processing of natural language. SAP owns text analysis technology in the form of several C++ libraries acquired from Inxight Software, such as the Linguistic Analysis, ThingFinder, Summarizer, and Categorizer.

In general, the term “pipeline” refers to a series of software components for data processing (or specifically herein, document processing), combined for particular purpose. Typically, each application requires a different pipeline configuration (with custom processing code) for its unique purpose.

In general, the term “collection-level analysis” refers to text analysis performed on multiple documents (in contrast to document processing, which generally is performed on a single document). If a system takes the data that comes from document processing and stores it in a database, then collection-level analysis can connect references to people, companies, products, etc., between documents, forming a large graph of connections. Another kind of collection-level analysis is aggregation, in which statistics are compiled over a set of documents. For example, customer sentiments (positive and negative) can be averaged by product, brand, time, and so on.

In general, “throughput” refers to the amount of data (herein, document text) processed per unit time. Here, we will define throughput in units of megabytes of plain text processed per hour (MB/hr). Plain text is extracted from many document file formats, such as PDF, Microsoft Word™, or HTML. We do not measure throughput based on the size of the original file, but rather on the size of the plain text extracted from it.

In general, “scaling efficiency” refers to throughput compared to an imaginary ideal system with zero scaling overhead. So, if a text analysis library has a throughput of 10 MB/hour on a single CPU core, reading and writing to the local disk, then an ideal system with 100 cores would have a throughput of 1000 MB/hour. If the actual system being measured has a throughput on 100 cores of 900 MB/hour, then its scaling efficiency is 90%.

In general, the following description details a system that implements a scalable document processing service. The system is an on-demand network service that supports multiple concurrent clients, and is efficient, dynamically and linearly scalable, fault-tolerant using inexpensive hardware, and extensible for vertical applications. The system is built on a cluster of machines using a “space-based architecture” pattern, a customizable document processing pipeline, and mobile code.

According to an embodiment, the elements include a service front-end that accepts asynchronous requests from clients to obtain and process documents from a source system through a pipeline with a given composition. The front-end places tasks containing document identifier strings into a producer/consumer queue running on a separate machine. Worker processes on other machines take tasks from the queue, download the document from the source system and the code for the pipeline from the application, process the document through the pipeline, send the results to another system, and place some task status information back in another queue.

If a worker crashes, the task is placed back on the queue, and another worker will re-try it. By separating on the network the control data from the content data (documents and results), and by performing the processing without further networking within the pipeline, the system achieves a maximal throughput for a given network bandwidth. The system capacity may be expanded without interrupting service by simply starting more workers on additional networked machines. Having no bottlenecks, system throughput is limited only by network bandwidth. The system is naturally (automatically) load balanced, and achieves full and optimal CPU usage without active monitoring or human intervention, regardless of the mix of clients, pipeline configurations, and documents.

### Overview of Document Processing System

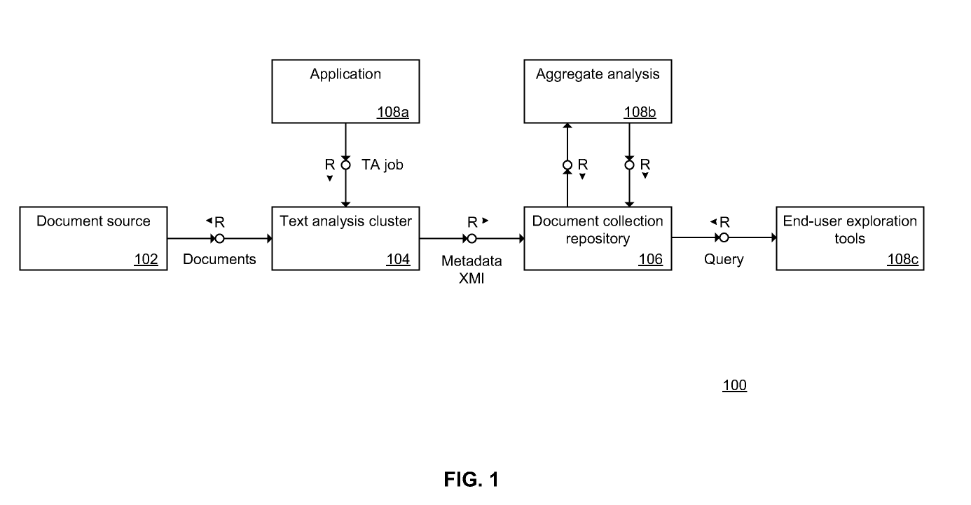

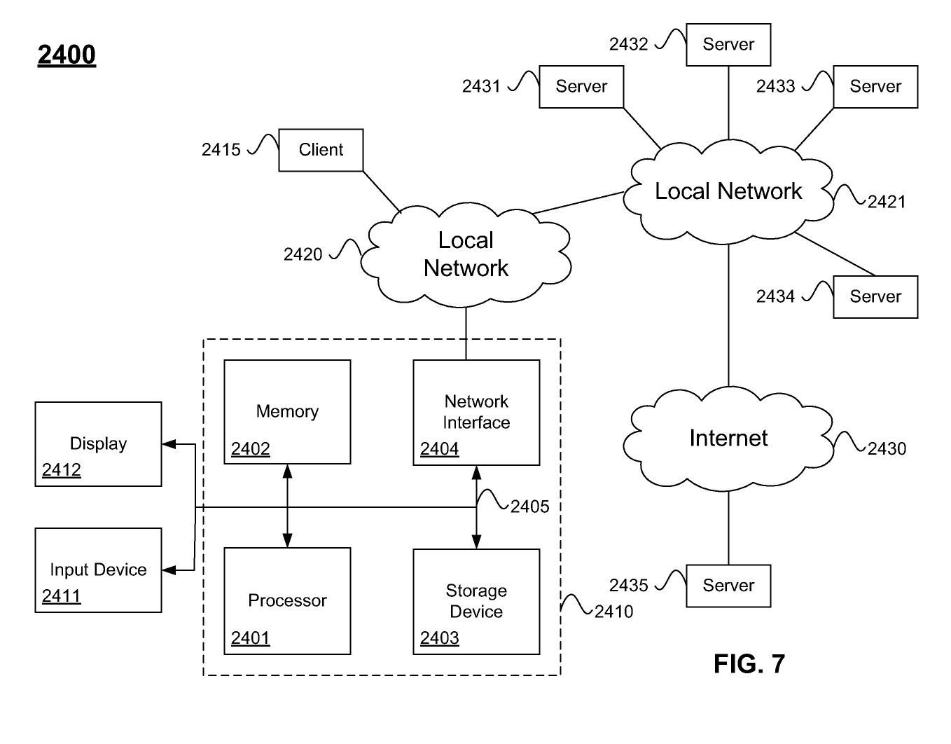

FIG. 1 is a block diagram of a system 100 for processing documents. The system 100 includes a document source computer 102, a text analysis cluster of multiple computers 104, a document collection repository server computer 106, and client computers 108a, 108b and 108c. (For brevity, the description may omit the descriptor “computer”, “server” or “system” for various components; e.g., a “document collection repository server computer” may be referred to as a “document collection repository” or simply “database”.) These components 102, 104, 106 and 108a-c are connected via one or more computer networks, e.g. a local area network, a wide area network, the internet, etc. Specific hardware details of the computers that make up the system 100 are provided in FIG. 7.

The document source 102 stores documents. The document source 102 may include one or more computers. The document source 102 may be a server, e.g. a web server, an email server, or a file server. The documents may be text documents in various formats, e.g. portable document format (PDF) documents, hypertext markup language (HTML) documents, word processing documents, etc. The document source 102 may store the documents in a file system, a database, or according to other storage protocols.

The text analysis system 104 accesses the documents stored by the document source 102, performs text analysis on the documents, and outputs processed text information to the document repository 106. The processed text information may be in the form of extensible markup language (XML) metadata interchange (XMI) metadata. The client 108a, also referred to as the application client 108a, provides a user interface to business functions, which in turn may make requests to the text analysis system 104 in order to implement that business function. For example, a user uses the application client 108a to discover co-workers related to a given customer, which the application implements by making a request to the text analysis system 104 to analyze that user's email contained in an email server, and using a particular analysis configuration designed to extract related people and companies. The text analysis system 104 may be one or more computers. The operation of the text analysis system 104 is described in more detail in subsequent sections.

The document collection repository 106 receives the processed text information from the text analysis system 104, stores the processed text information, and interfaces with the clients 108b and 108c. The processed text information may be stored in one or more collections, as designated by the application. The client 108b, also referred to as the aggregate analysis client 108b, interfaces with the document repository 106 to perform collection-level analysis. This analysis may involve queries over an entire collection and may result in insertions of connections between documents and aggregate metrics about the collection. The client 108c, also referred to as the exploration tools client 108c, interfaces with the document repository 106 to process query requests from one or more users. These queries may be for the results of the collection-level analysis, for the results of graph traversal (the connections between documents), etc. The operation of the document repository 106 is described in more detail in subsequent sections. In addition, further details of one possible implementation of the document repository 106 are provided in U.S. application Ser. No. ______ for “System and Method Implementing a Text Analysis Repository”, attorney docket number 000005-017500US, filed on the same date as the present application.

Note that it is not required for the document repository 106 to store all the documents processed by the text analysis system 104. The document repository 106 may store all of, or a portion of, the extracted entities, sentiments, facts, etc.

Within the system 100, embodiments of the present invention relate to the text analysis system 104. The text analysis system 104 runs on machines that are separate from those that run the application systems (“clients”), such as the application client 108a. The application system 108a makes requests over the network to the service to process documents through a given set of steps (a “pipeline”), and then consumes the resulting data via the network (either directly from the TA System 104), or indirectly from the repository 106 into which the system 104 has placed the data).

The TA system 104 can provide high levels of throughput by using many hundreds of CPUs on many separate machines connected by a network (a “cluster”). It provides this scalability in a way that results in minimum hardware costs, by using inexpensive computers and network equipment, and making optimal use of that hardware. The throughput capacity of the TA system 104 can be easily raised without interrupting service by adding more computers on the network.

The TA system 104 is fault-tolerant. If a machine in the cluster fails, there is no data loss, and other machines will restart the processing of the documents that were interrupted.

The TA system 104 can accept simultaneous requests from many clients, and provide equal throughput and “fair” response time to all. Each client can configure a different document processing pipeline (containing different code and different reference data), and the TA system 104 will download the code from the application and run all the pipelines concurrently without losing processing efficiency. It maintains this efficiency automatically, without any human intervention.

The commercial benefits include saving costs. First, since each application development group would have to solve these problems separately, the TA system 104 saves development costs by solving it once, and allowing the solution to be re-used. The library that the application must integrate into its code in order to submit jobs to the service has a simple programmatic interface that is easy for developers to learn, and uses little memory and CPU, so having little impact on the application.

Second, a single system instance that can serve many application clients concurrently, and uses the hardware efficiently, lowers capital expenses compared to each application development group operating their own, dedicated, separate set of machines.

Finally, by having a system that scales linearly while maintaining its efficiency regardless of the mix of clients, and does so automatically (requiring no human intervention), it saves operational costs.

### Overview of Text Analysis System

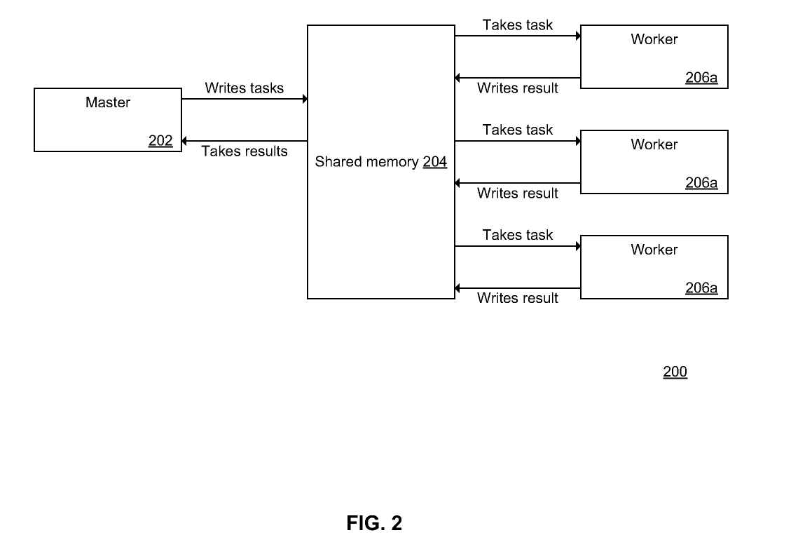

The TA system 104 provides linear scalability and fault-tolerance by using a space-based architecture to organize a cluster of machines, using a “master-worker” design pattern. FIG. 2 shows an example of such a cluster 200 using a master-worker design pattern. The cluster 200 includes a master 202, a shared memory 204, and a number of workers 206a, 206b and 206c. These components may be implemented by various computer systems; for example, a server computer may implement the master 202 and the shared memory 204, and client computers may implement the workers 206. A network (not shown) connects these components.

The shared memory 204 implements a distributed (networked) producer-consumer queue, built on a tuple-space, a kind of distributed shared memory. The master 202 acts as a front-end to the cluster 200, accepting processing requests from application clients over the network. A processing request is in essence a document pipeline configuration (specification of the processing components and reference data), plus a set of documents or a way to get a set of documents. For example, the request could specify to crawl a certain web site with certain constraints, or query a search engine with certain keywords. It could also be an explicit list of identifiers of documents to process. For the pipeline in this implementation, an embodiment uses Apache™ Unstructured Information Management Architecture (UIMA), but other technologies could also be used. In UIMA, a pipeline is called an “analysis engine”, and the configuration given in the request is a Java object representing a UIMA “analysis engine description”. Together, this pipeline configuration and the document crawling or searching information form a processing request to the master 202. Many applications may send many requests concurrently.

The master 202 breaks down the request into tasks. In the case of document processing, a task represents a small number of documents, usually just one. Multiple documents may be placed in a single task if the documents are especially small, so that system efficiency can be maintained. Note that the task does not contain the document itself, but rather an identifier of the document, typically a URL. So a task is relatively small, usually in the range of 100 to 200 bytes. The task also contains a reference to the pipeline configuration.

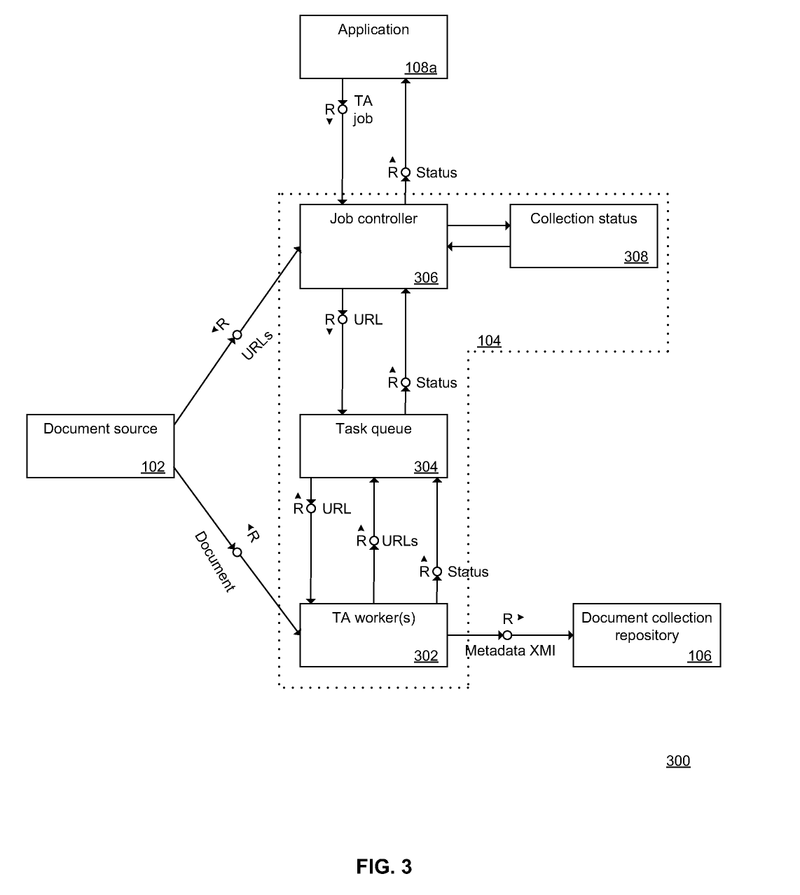

FIG. 3 is a block diagram of a text analysis system 300 showing further details of the text analysis cluster 104 (cf. FIG. 1). As discussed above, the text analysis cluster 104 may be implemented by multiple hardware devices that, in an embodiment, execute various computer programs that control the operation of the text analysis cluster 104. These programs are shown functionally in FIG. 3 and include a TA worker 302, a task queue 304, and a job controller 306. The TA worker 302 performs the text analysis on a document. There may be multiple processing threads that each implement a TA worker 302 process. The job controller 306 uses collection status data (stored in the collection status database 308). The embodiment of FIG. 3 basically implements a networked producer/consumer queue (also known as the master/worker pattern).

According to an embodiment, the job controller 306, the task queue 304 and the TA workers 302 are implemented by at least three computer systems connected via a network. The task queue 304 may be implemented as a tuple-space service. The master (the controller 306) sends the tasks to the space service, which places them in a single, first-in-first-out queue 304 shared by all the tasks of all the jobs of all the clients. An embodiment uses Jini/JavaSpaces to implement the space service; other embodiments may use other technologies.

There are many worker processes 302 running on one or more (often many) machines. Each worker 302 connects to the space service, begins a transaction, and requests the next task from the queue 304. The worker 302 takes the document identifier (e.g., URL) from the task, and downloads the document directly from its source system 102 into memory. This is the first and only time the document is on the network.

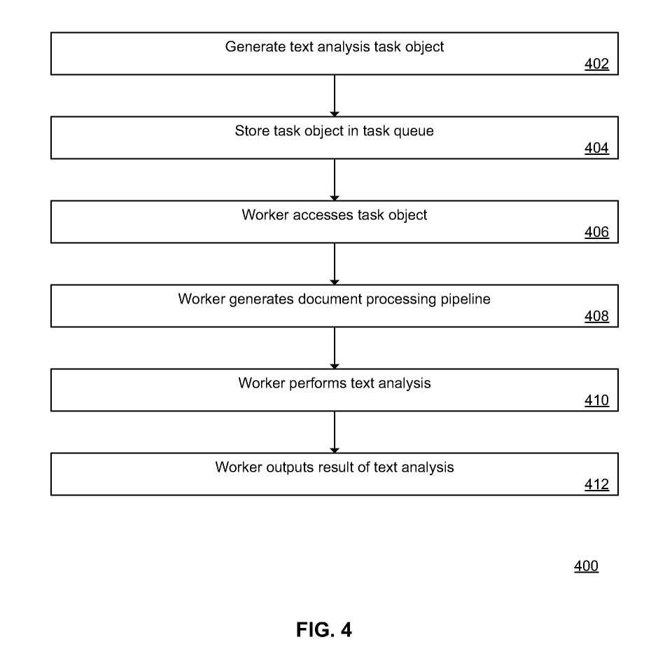

FIG. 4 is a flow diagram of a method 400 of processing documents. The method 400 may be performed by the TA system 104 (see FIG. 3), for example as controlled by one or more computer programs. The steps 402-412 are described below as an overview, with the details provided in subsequent sections.

At 402, the controller system generates a text analysis task object. The text analysis task object includes instructions regarding a document processing pipeline and a document identifier. The document identifier may be a pointer to a document location such as a URL. Further details of the document processing pipeline are provided in subsequent sections.

At 404, the text analysis task object is stored in a task queue as one of a plurality of text analysis task objects. For example, the controller 306 (see FIG. 3) sends the text analysis task object “URL” to the task queue 304 for storage. Multiple task objects may be stored in the task queue in a first-in-first-out (FIFO) manner.

At 406, a worker system accesses the text analysis task object in the task queue. The worker system is generally one of a number of worker systems that interact with the task queue to access the task objects on an as-available basis. For example, when the tasks queue operates in a FIFO manner (see 404), the first worker to access the task queue accesses the oldest task object. Other workers then access others of the task objects on an as-available basis. When the first worker is done with the oldest task object, that worker is available to take another task object from the task queue.

At 408, the worker system generates the document processing pipeline according to the instructions in the text analysis task object. In general, the pipeline is an arrangement of text analysis plug-ins and configuration information for the text analysis plug-ins. Further details of the document processing pipeline are provided in subsequent sections.

At 410, the worker system performs text analysis, using the document processing pipeline, on a document identified by the document identifier. For example, when the document identifier is a URL, the worker 302 obtains via the network a document stored by the document source 102 as identified by the URL.

At 412, the worker system outputs a result of performing text analysis on the document. For example, the worker system 302 may output text analysis results in the form of XMI metadata to the document collection repository 106. In addition, the worker system 302 outputs status data to the task queue 304 to indicate that the worker system 302 has completed the text analysis corresponding to that task object.

Given the above overview, following are additional details of specific embodiments that implement the text analysis system and related components.

### Details of Text Analysis System

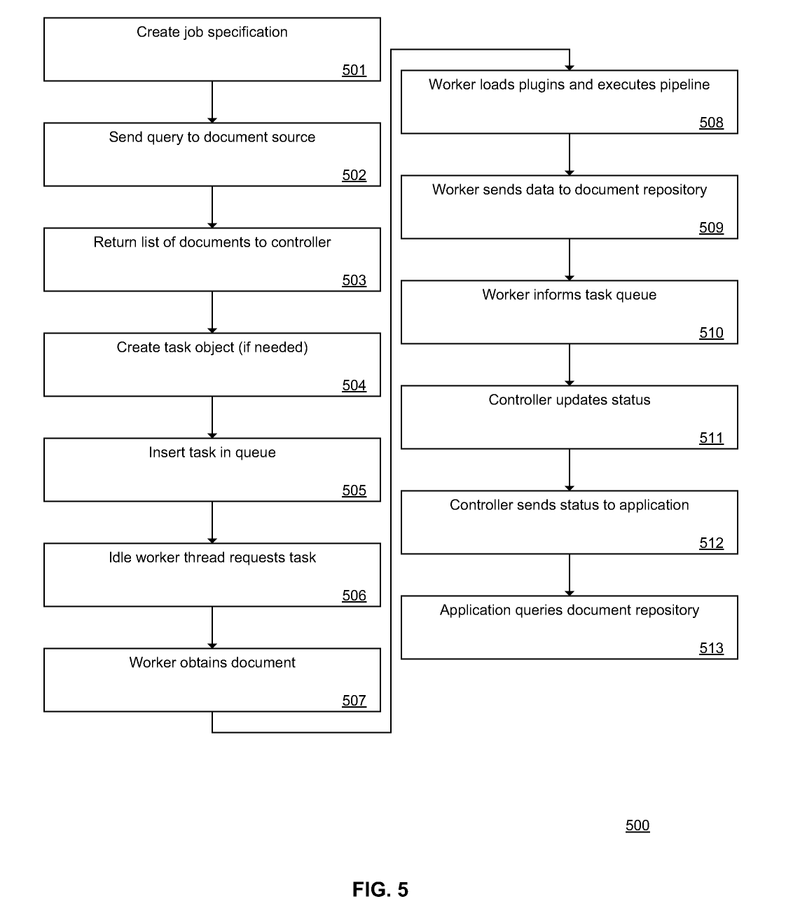

FIG. 5 is a flowchart of an example process 500 showing further details of the operation of the text analysis cluster 104 (see FIG. 3). The process 500 describes the processing involved for a job through the system from beginning to end. Imagine a scenario in which a user of SAP Customer Relationship Management (CRM) wants to process documents stored in that CRM system for the purpose of analyzing sentiment (SAP “voice of the customer”, or VOC). In this case, the sentiment analysis data is the only result data that the application developer desires to be stored in the document collection repository 106. The application developer has previously constructed a text analysis processing configuration that includes the VOC processing, and which, at the end, sends the sentiment data to the repository. The developer has saved this configuration and given it a unique name. The user indicates in the application 108a which documents he wants processed from the CRM system.

At 501, the CRM application 108a creates a job specification containing a query representing the user's desired set of documents, and the name of the VOC processing configuration. The CRM application 108a sends the job to the job controller 306 and blocks on the request, waiting for the job to complete. In an alternative embodiment, the CRM application 108a does not block on the request (implementing a non-blocking mode).

At 502, the controller 306 sends the query to the document source 102; in this case, the CRM system.

At 503, the CRM system returns to the controller 306 a list of URLs of documents that match the query.

At 504, for each URL, the controller 306 queries the collection status database 308 for the date/time that the URL was last processed (if at all), and the checksum. If the document is new or modified since then, then the controller 306 creates a task object containing the URL and the name of VOC configuration. The controller 306 sends each task to the task queue 304, and waits for status objects from the task queue 304.

At 505, the task queue 304 inserts the task into the queue along with the tasks from all the other jobs being processed.

At 506, a worker thread (e.g., 302) is not busy, and so it requests (via the task queue 304) a task from the queue. The task queue 304 returns a task from the top of the queue, and also an identifier for a new transaction. The many worker threads (multiple 302s) running on the many CPU cores in the cluster are all doing the same.

At 507, the worker 302 uses the URL from the task to obtain the document content from the CRM server (document source 102).

At 508, the worker 302 uses the VOC configuration to load the requested processing steps (plug-in libraries) and to execute a pipeline on the document. (The next section describes this in more detail.)

At 509, the worker 302 sends the resulting data to the document collection repository 106.

At 510, the worker 302 sends a “completed” status object for the URL back to the task queue 304 and commits the transaction. The worker 302 goes to 506, and starts on a new task.

At 511, the controller 306 receives the status object for the URL from the task queue 304. The controller 306 records the URL, the date/time, and the checksum in the collection status database 308. The controller 306 notifies the CRM application 108a of progress if the CRM application 108a has requested that (non-blocking mode).

At 512, when all status objects for all URLs are received, the job is complete, and the controller 306 returns status information for the job to the waiting CRM application 108a, and also records the job in the collection status database 308.

At 513, the CRM application 108a may now query the results from the document repository 106.

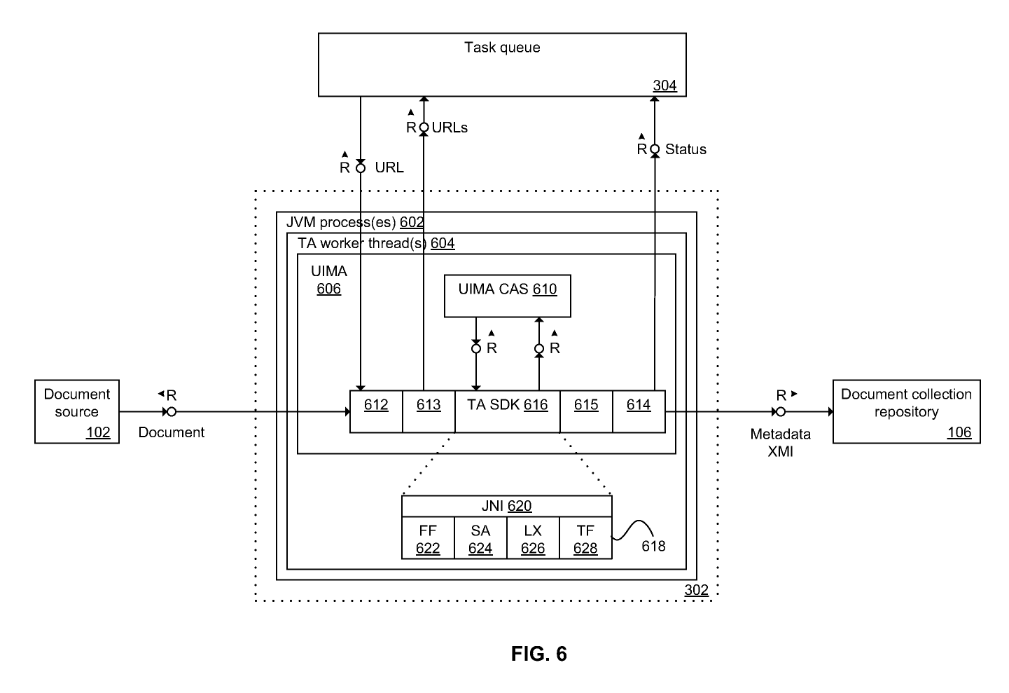

FIG. 6 is a block diagram showing further details of the text analysis cluster 104 (see FIG. 1) when it is executing a task as per 508 (see FIG. 5). More specifically, FIG. 6 shows the internals of a worker process (e.g., the TA worker 302). The TA worker 302 is implemented by a Java virtual machine (JVM) process 602 that in turn implements a TA worker thread 604 (or multiple threads). The TA worker thread 604 includes a UIMA component 606, which includes the UIMA CAS data structure 610. The text analysis pipeline is composed of several plug-in components, including the requester component 612, the crawler component 613, the TA DSK component 616, the extensible component 615, and the output component 614.

The requester component 612 requests a task from the Task queue 304, and using the document identifier found in the task, it retrieves the Document from the Document source 102, using, for example the HTTP protocol. The crawler component 613 parses the document and identifies links to other documents (such as typically found in HTML documents), and creates new tasks in the Task queue 304 for those documents. In effect, the crawler component 613 is a distributed web crawler. The TA SDK component 616 interfaces the Text Analysis C++ libraries 618 into UIMA 606.

The TA SDK plug-in 616 interfaces the UIMA component 606 with the Text Analysis software developer kit 618 via the Java™ network interface (JNI) 620, converting C++ data into UIMA CAS 610 Java data. As discussed in more detail in other sections, the Text Analysis SDK is written in C++ and includes a file filtering (FF) 622, a structure analyzer (SA) 624, a linguistic analyzer (LX) 626, and the ThingFinder™ (TF) entity extractor 628. (Further details regarding the plug-ins are provided below.)

The extensible component 615 represents a selection of plug-ins that the application developer has configured to perform the text analysis on the document. (Further details on configuring the plug-ins in the pipeline are provided below.)

The output handler 614 interfaces the worker thread 602 with the task queue 304 and the document repository 106. The output handler 614 sends the result data from the UIMA CAS 610 to the document collection repository 106.

According to an embodiment, the text analysis cluster 104 includes a number of machines, and there is one worker process per machine in the cluster. This worker process is a Java virtual machine running one thread per worker. Since text analysis is CPU-intensive and the blocks for I/O are a very small percent of the elapsed time (just to read the document from the network and write the results to the network), an embodiment typically implements one worker per CPU core. So an eight-core machine cluster would have eight worker threads in one JVM process. Note that each document is processed in a single thread. This embodiment does not parallelize the processing of a single document; instead the job as a whole is parallelized.

The worker 302 starts by requesting a task from the queue 304. The worker 302 receives back a task object and a transaction identifier. A task is an instance of a class which implements an execute( ) method. When the worker thread 604 calls execute( ), this triggers the class loader to download all the necessary Java classes.

In our case, the execute( ) method implements a text analysis pipeline. This first gets a URL from the task, and uses it to download the document from the source 102. This may require authentication.

Next, execute( ) instantiates the UIMA CAS 610 using the configuration information in the task. This causes the UIMA component 606 to load the classes of all the configured annotators (text analysis processors), and thereby create a UIMA “aggregate analysis engine”, i.e., a text analysis pipeline. These annotators (e.g., 613, 616, 615 and 614) may be any text processing code the application needs.

The annotators then run sequentially in the thread, each one first reading some data from the CAS 610, doing its processing, and then writing some data to the CAS 610.

The first annotator is typically a file filter, to extract plain text or HTML text from various document formats. This may be the FF C++ library 622 (a commercial product), or it could be the open-source Apache Tiki filters. After filtering, if HTML was the result, then as the worker 302 parses the HTML, it will discover links to other pages. The worker 302 first checks if the URL is a duplicate of one already processed by looking in the collection status database 308 (see FIG. 3). If it is not a duplicate, then the worker 302 sends these URLs to the queue 304 as additional tasks. So the worker 302 implements, in essence, a distributed, scalable web crawler.

Some of the text analysis libraries are shown in FIG. 6 and include the LX linguistic analyzer 626 (LXP™), the TF entity extractor 628 (ThingFinder™), the SA structure analyzer 624, and/or the Categorizer™ analyzer (not shown). These are written in C++, so FIG. 6 shows these in a separate layer, since they may be linked in as DLLs, and so may be pre-installed on the machine (if the Java class loader cannot download them). Resource files (name catalogs, taxonomies, etc), however, may come from a file server or HTTP server, where they have been installed.

In addition, the UIMA analysis engine 606 may include a VOC transform annotator (not shown), as previously described. Also, there are many open-source and commercial annotators available, so this represents an opportunity to create a partner eco-system for text analysis.

Then, the worker thread 604 sends to the queue 304 a status object that contains any failure information and performance statistics.

Finally, the worker thread 604 commits the transaction for the task with the queue 304.

The other worker threads are all doing the same thing. When a worker thread 604 finishes a task (the execute( ) method returns), it requests another task from the queue. If there are no tasks left, then the request blocks and the worker thread 604 sleeps until a task becomes available.

Note that in the TA system 104, there are many JVM processes 602, one per machine. There may be hundreds of machines. Each machine may have multiple CPU cores, and there is one TA worker thread 604 per core. For example, a machine with eight cores means eight threads, i.e. eight workers.

Each thread 604 has an instance of a UIMA CAS 610. In other words, the system 104 processes one document per thread. So eight cores means that eight documents can be processed at once (concurrently). There are no dependencies between documents, so no synchronization issues. The system 104 applies one CPU core per document, since in general, Annotators are not written to multi-thread within a document. An Annotator could create threads, however the system 104 would not necessarily be aware of it.

Within the worker thread 604, the Annotation Engine (e.g., the pipeline 612, 613, 616, 615, and 614) proceeds left to right. First, the worker 302 takes a task from the queue 304 (starting a transaction with the Space), and gives the identifier string from the task to the first Annotator 612. This Annotator 612 uses the identifier string (probably a URL) to obtain the document content from the source system 102. This is the first and only time the document is on the network.

Next, the engine filters the plain text or HTML from the content, and places it in the CAS 610. In the case of HTML, the system 104 also extracts links (href's), wraps these URLs in new Task objects, and send the Tasks to the queue 304 for other workers to process. Essentially, the system 104 implements a distributed, scalable crawler.

Next, various Annotators (e.g., 616, 622, 624, 626, 628) operate on the plain text or HTML, reading data from the CAS 610, and writing their result data to the CAS 610, as configured according to the extensible component 615. This all happens in the local address-space—no networking is required. Some of the Annotators are SAP's TA libraries (File Filtering 622, Structure Analysis 624, Linguistic Analysis 626, ThingFinder 628). These are written in C++ (e.g., as implemented by the TA SDK 618), and the system 104 accesses them using their Java interfaces (e.g., via the JNI 620). A bit of additional code copies the result data into the CAS 610.

Finally, the last Annotator 614 (a CasConsumer in UIMA terminology) sends the CAS data to a repository (e.g., 106) using a database transaction, sends a Status object back to the Space (e.g., the task queue 304) to indicate completion, and commits the transaction with the Space and the transaction with the database (e.g., the repository 106).

If the worker's Lease with the Space expires (i.e. the worker does not extend the Lease after a certain time), then the Space assumes that the worker has died, and returns to the queue the Task that the worker had taken, so that some other worker may take it. Likewise, if the worker crashes before it commits the transaction to the database, then the database will rollback the transaction, and remove the data. In this way, the system is fault-tolerant if a machine in the cluster crashes.

### Overview of the Text Analysis Libraries

The text analysis cluster 104 (see FIG. 1) may implement one or more text analysis libraries (see 618). According to an embodiment, the text analysis cluster 104 implements four primary libraries: Linguistic X Platform, ThingFinder, Summarizer, and Categorizer. All have been developed in C++.

Linguistic X Platform. At the bottom of the stack is the Linguistic X Platform, also known as LX or LXP. The “X” stands for Xerox PARC, since this library is based on code licensed from them for weighted finite state transducers. LXP is an engine for executing pattern matches against text. These patterns are written by professional computational linguists, and go far beyond tools such as regular expressions or Lex and Yacc.

The input parameter to these function calls is a C array of characters containing plain text or HTML text, and the output (i.e. the return value of the functions) is C++ objects that identify stems, parts of speech (61 types in English), and noun phrases. LXP may be provided with files containing custom dictionaries or linguistic pattern rules created by linguists or domain experts for text processing. Many of these files are compiled to finite-state machines, which are executed by the processing engine of the text analysis cluster 106 (also referred to as the Xerox engine when specifically performing LXP processing).

LXP™ can detect the encoding and language of the text. In addition, the output “annotates” the text—that is, the data includes offsets into the text that indicate a range of characters, along with some information about those characters. These annotations may overlap, and so cannot in general be represented as in-line tags, a la XML. Furthermore, the output is voluminous, as every token in the text may be annotated, and often multiple times.

ThingFinder™ builds on the LXP to identify named entities—companies, countries, people, products, etc.—thirty-eight main types and sub-types for English, plus many types for sub-entities. As with LXP, ThingFinder uses several finite-state machine rule files defined by linguists. Of particular importance are the CGUL (Custom Grouper User Language) rule files that the customer may use to significantly extend what ThingFinder recognizes beyond just entities, but to “facts”—patterns of entities, events, relations between entities, etc. CGUL has been used to develop application-specific packages, such as for analyzing financial news, government/military intelligence, and “voice of the customer” sentiment analysis.

Summarizer™, like ThingFinder™, builds on LXP. In this case, the goal is to identify key phrases and sentences. The data returned from the function calls is a list of key phrases and a list of key sentences. A key phrase and a key sentence have the same simple structure. They annotate the text, and so have a begin offset and length (from which the phrase or sentence text may be obtained). They identify, as integers, the sentence and paragraph number they are a part of. Finally, they have a confidence score as a double. The volume of data is fairly small—the Summarizer may only produce ten or twenty of each per document.

Categorizer™ matches documents to nodes, called “categories”, in a hierarchical tree, called a “taxonomy”. Note that this use of the word is unrelated to the concept of taxonomies as otherwise used at SAP. A category node contains a rule, expressed in a proprietary language that is an extension of a full-text query language, and that may make reference to parts of speech as identified by LXP. So, in essence, Categorizer™ is a full-text search engine that knows about linguistic analysis.

These rules are typically developed by a subject-matter expert with the help of a tool with a graphical user interface called the Categorizer Workbench™. This tool includes a “learn-by-example” engine, which the user can point at a training set of documents, from which the engine derives statistical data to automatically produce categorization rules, which help to form the taxonomy data structure.

The data returned by Categorizer™ functions is a list of references to category nodes whose rules matched the document. A reference to a category node consists of the category's short name string, a long path string through the taxonomy from the root to the category, a match score as a float, and a list of reasons for the match as a set of enumerated values. The volume of data per document is fairly small—just a few matches, often just one.

### Features of the TA Service

Embodiments such as that shown in FIG. 3 and FIG. 6 may have one or more noteworthy features. First, they have linear scalability. The worker 302 downloads Java code from the application 108a for the processing components of the pipeline specified in the task, then executes the pipeline on the document in memory. The processing happens on the worker's local machine, in the local address space, so there is no networking or inter-process communication within the pipeline (only at its ends). Notice that the workers never communicate with each other, only with the space server (e.g., the task queue 304).

Second, they conserve network bandwidth. The last component in the pipeline typically sends the result data of the pipeline processing to some destination, e.g. back to the application 108 or to the document collection repository 106. This is the first and only time the result data is on the network. In order to ensure no data loss, if the document collection repository 106 supports it, the worker will transactionally commit the result data. Finally, the worker sends a small status object back to the space server and commits the transaction with the space server for that task.

Third, they implement graceful failover. If the worker fails while processing a task (e.g., the worker process crashes), then the transaction with the space server eventually times out, and the space server rolls back the transaction, causing the task to be placed back on the queue for another worker to take. There is no data loss. Either the worker sends the result data to the destination, sends the status object to the space server, and commits the task with the space server, or no data is created anywhere and the task is restarted by another worker. There is never partial result data produced.

More details regarding these and other features are provided below.

Reliability

The text analysis system 104 (see FIG. 3) protects the application client (e.g., 108a) from crashes in the text analysis code because that code runs in separate process (indeed, on a separate machine) from the application. If that code crashes (killing its worker process), then the system tolerates the fault (no data loss, no partial results) through the use of transactions with the repository 106 and with the space server (e.g., 304), and the task is re-attempted by another worker in the cluster 104.

Note that worker processes don't require expensive computers—just a processor, memory, and a network card. No expensive disks such as redundant array of independent disk (RAID) controllers, solid-state drives, or fiber-optic network-attached storage are needed or wanted. The system 104 does not care if these cheap machines die because the system will recover. So instead of requiring $50,000 blade machines in special (expensive) integrated enclosures, the system can use cheap, separate $2,000 boxes.

### Throughput and Efficiency

The system 104 provides linear scaling because additional workers can be added to the cluster, which will cause tasks to be taken from the queue proportionally faster. Each additional worker, whether the second or the 1000th, incrementally improves throughput equally, so efficiency is maintained.

The system can also easily and dynamically expand its capacity without interrupting service (“elastically”). Additional workers can be brought on-line (for example, through a cloud virtualization infrastructure), and they simply start taking tasks from the space server.

By separating the paths through the system for the control information (i.e. the tasks) and the bulk of the data (i.e. the document content and result data), bottlenecks are reduced in the system, leaving only the network bandwidth as a limitation to system throughput capacity. Note that there need be no reading from or writing to disks in the system (except possibly for the repository, which is outside the scope of the invention). Note also that the document is on the network only once, and the result data is on the network only once. This means that the network bandwidth is used optimally. For a given network speed and for a given network protocol used to transfer documents and result data, this system achieves maximum throughput. This means we can get much farther than other systems on inexpensive network equipment, such as standard gigabit Ethernet. High throughput can be achieved without having to use expensive 10-gigabit networking hardware.

The system also uses the CPUs of the workers optimally. The workers are naturally load-balanced. That is, regardless of how the many different pipelines of the application clients are configured, and regardless of the format or size of the documents processed, the CPUs are always at or very near 100% utilization (as long as there are at least as many tasks as workers). A worker takes a task, processes the document at full CPU utilization in the local address space (no networking within the pipeline), and then takes the next task. There is very little time spent blocking on I/O (just retrieving the document and sending the result data), and the worker is continuously busy until there are no more tasks in the queue. It doesn't matter how long each document takes, or how much that time varies between documents, the worker is always busy. There is no central load balancer monitoring the CPU usage of the machines in the cluster and trying to actively distribute the work. There is no human trying to configure different machines for different tasks, based on the current work mix. Any machine can execute any task using any pipeline configuration without affecting system efficiency. The system will automatically just keep executing near 100% utilization regardless of what kinds of requests or configurations are thrown at it.

By using inexpensive hardware optimally, without active balancing or human intervention, to serve any mix of client requests, the system lowers both the capital costs and the on-going operational costs of performing text analysis.

According to an embodiment, a worker implements a Java virtual machine for executing the text analysis pipeline. The Java virtual machine may support multi-core and hyper-threaded CPUs. Multiple workers may be executed by an single CPU by mapping each Java thread to an OS/hardware thread. Thus, there may be only one Java virtual machine process per machine that executes the workers, regardless of the number of CPUs. All the workers on the machine may share resources in memory such as name catalogs and taxonomies.

### Multi-Client Features

The text analysis system 104 may provide fair service to all clients (e.g., applications) 108a concurrently. Each client 108a submits its processing request, the Job Controller 306 (the “master”) breaks down the request into tasks, and the tasks are inserted into the task queue 304 in the space server. The Job Controller 306 can implement different definitions of “fairness” to the clients 108a by ordering the tasks in the queue 304 in different ways. For example, equal throughput can be ensured by ordering tasks in the queue 304 such that each client's request is getting an equal share of the system's total processing cycles. This may involve observing throughput for each request in order to predict future performance.

Sometimes it is necessary for a request to go through first. For example, the user is waiting on the results, while other requests may be batch processes, and response time isn't so important. For this case, the system 104 provides request priorities. Tasks belonging to requests with higher priorities go to the front of the queue 304, before tasks belonging to requests with lower priorities.

Other queuing options are as follows. One option is first come, first served. Another option is to take one task from each job, then repeat with another task from each job, etc.

Another multi-client issue is that each client 108a typically uses a different pipeline configuration, with at least some different code. For example, based on the pattern-matching rules installed into ThingFinder (sentiment analysis rules, for example), a brand-monitoring application may need to process the data output from ThingFinder into a more convenient form, or do other kinds of text analysis on each document. This code would be specific to that application. Other applications are submitting different pipeline configurations with different custom code.

The system 104 addresses this issue by allowing the application 108a to specify this additional code in its pipeline configuration when it submits a job (e.g., the UIMA analysis engine description object). This process may be referred to as “code mobility”. When this configuration information arrives at the worker 302 (as part of the task object), the worker 302 downloads the code from the application 108a. The system 104 implements this according to an embodiment using the Java feature “Remote Method Invocation” and the JavaSpaces network protocol “Jini”. When references to these classes were made in the job object (i.e. via the UIMA analysis engine definition object that is part of the job object), the classes were annotated with a URL pointing to the system where they reside (in this case, the application). Later, a special class loader in the worker JVM transfers the code from that system using the URL. This means that the custom code that the application developer wants in the pipeline doesn't have to be manually installed on each of the worker machines. Instead, the worker simply pulls the code from the application as needed.

### TA System as Viewed from the Application

The following steps may be performed by an application developer to process documents using the TA system 104. The details are specific to an embodiment implemented using Java, Jini, Eclipse, UIMA, and various text analysis components such as ThingFinder, Categorizer, etc.

First, write a web crawler. The crawler implements the SourceConnection interface, providing an iterator that returns document URLs.

Second, write an input handler. The input handler is a UIMA Annotator at the beginning of the Analysis Engine (e.g., the pipeline as implemented by UIMA) that takes the given URL, downloads the document from the document source (using HTTP typically), and puts the document bytes into a UIMA CAS 610. The system 104 provides a stock “Web” input handler that understands HTTP URL's.

Third, write an output handler. The output handler is an Annotator at the end of the Analysis Engine that reads the extracted entities, classifications, and other data from the CAS 610 and writes them to the repository 106, for example to the AIS database. Output handlers can send UIMA data to any destination with which Java can communicate.

Fourth, write a work completion handler. This handler runs in the application and is called back from the TA Service during processing as each document completes, giving status on that document. The application may use this to track progress of the TA job, and to update the user's screen.

Fifth, configure a pipeline. Use the UIMA plug-in to Eclipse to create a configuration file (XML) that specifies the Analysis Engine. The file specifies the Web input handler (crawler), a file filtering annotator, the ThingFinder annotator, the Categorizer annotator, and the stock AIS output handler.

Sixth, load the pipeline. In the application, read in the Analysis Engine configuration file, and override ThingFinder or Categorizer options if desired.

Seventh, create a TestAnalysisService instance. Call the constructor, passing the configuration file and the work completion handler.

Eighth, create a connection to the web server. Instantiate the web crawler SourceConnection, giving the URL to the desired web site (<hxxp://www.amazon.com>, for example).

Ninth, run the specified TA job. Use the TextAnalysisService to create a job, giving it the SourceConnection, and run the job asynchronously (i.e. the application need not wait).

The TA System 104 iterates through the documents returned from the web crawler, runs the given Analysis Engine on each document, and calls the work completion handler with status for each one. As a side effect of running the job, entities and classifications have been inserted into AIS (i.e. the result data need not be returned to the caller). When the job completes, the application 108a gets information on the job's status (overall success, completion time, etc.). The data in AIS is then ready for collection-level analysis (e.g., by 108b) and consumption by the application.

In addition to this mode, which asynchronously processes multiple documents by connecting to a source and sending results to a destination, the TA System 104 also provides processing variations which take the documents in the request, and/or return the results to the caller, and/or process just a single document. However, asynchronous is the preferred method, since the others may create performance bottlenecks that could greatly reduce throughput and scalability.

### Cluster Details

As discussed above, an embodiment of the TA Server 104 may be implemented using Java, JavaSpaces, and Jini. When a worker takes a task, it starts a Jini transaction with the Space. The worker downloads the Java classes for the objects in the task, and processes the task. (These functions may be referred to using the terms “Command Pattern” and “Code Mobility”.)

When the worker is done, it writes a result status object for the given document back to the Space, and commits the transaction. If the worker dies, the Space will detect it (lease expires), and rollback the transaction, returning the task to the queue for another worker to take. The process then repeats until the task queue is empty. Notice that workers need not communicate directly with each other.

Meanwhile, other workers are doing the same, and the master is waiting for result status objects to appear in the Space. When the master has collected result status for all its tasks, it knows that the job is complete (possibly with some failed documents).

Notice that, thanks to Java dynamic class loading and remote method invocation, there are no network service schemas to define, no code to generate, and no data to transform when making a network call. Changing what a task does or adding new analysis code to a task just requires editing the Java code and recompiling. All the networking and code updating is handled automatically, by Jini.

### Task Object Details

As discussed above, a processing job consists of a number of documents and a definition of a pipeline of document processors (such as ThingFinder and Categorizer). The TA System 104 (acting as the master) typically creates each task as one document to process. If the documents are especially small, then a task might reference several documents in order to overcome the overhead of the cluster and maintain throughput. The task contains just document identifier strings (usually URLs), and not the document content itself, because a JavaSpace is meant to coordinate services, not to transfer huge quantities of data around the network. (The JavaSpace server could become a network bottleneck if all document content had to pass through it.)

The task object created by the master has code (e.g., Java classes) that calls the Analysis Engine (e.g., the pipeline as implemented by UIMA). When the worker takes this task, it starts a transaction with the Task queue (i.e. the JavaSpace), and then downloads the classes from the master and executes the Analysis Engine (e.g., UIMA). For each document identifier string in the task, the worker performs the following steps. First, it downloads the document content from some source. Second, it calls the Analysis Engine, giving the Analysis Engine the document content. Third, it sends the extracted results to some destination (such as the repository 106). Fourth, it creates a status object for the document.

The worker 302 collects the status data from its one or few documents into a list, and writes the list back to the JavaSpace server (e.g., the task queue 304), thereby completing the task. Finally, it commits the transaction with the JavaSpace server.

The ability for each application to extend the pipeline with its own custom document processing code is enabled by UIMA, through its Annotators and Analysis Engines. A pipeline consists of a number of document processors, which an application might want to have executed in various orders, or even make decisions about order and options of one processor based on the output of another processor.

To support these customizations, a UIMA Analysis Engine may use a “flow controller” (part of the UIMA API) which, like an Annotator, is configured from an XML file into the Analysis Engine, and the code for the flow controller is downloaded by the workers. An application can then write a flow controller that plugs into the Analysis Engine and calls the Annotators in the desired order. A flow controller may be written in any language supported by the Java Virtual Machine, such as Python, Perl, TCL, JavaScript, Ruby, Groovy, or BeanShell.

Data Handler Details

As discussed above, to reduce network traffic, an embodiment transfers the document directly from its source (e.g., 102) to the worker (e.g., 302), and the results directly from the worker to its destination (e.g., 106). For this, data handler plug-in points are defined in the pipeline.

A task includes not the text content, but rather document identifiers that can be used to obtain the text. Only these short identifier strings pass through the Space (e.g., the task queue 304). When the master (e.g., the job controller 306) creates a task, it plugs in input handler code that knows how to interpret this string. When the task and handler code are run in the worker, the handler connects directly to the document source, and requests (“pulls”) the text for the given document identifier.

These identifier strings may differ in various embodiments according to the specifics of the input handler code. For example, they could be HTTP URLs to a web server, or database record IDs to be used in a Java database connectivity (JDBC) connection. These identifier strings are generated by the source connector (implemented by the application developer), possibly in conjunction with an external crawler, depending on how the system is configured.

Similarly for the results, the application plugs in handler code for output. In the worker, this code connects to a destination system and sends (“pushes”) the result data for the document, using one or more network protocols and data formats as implemented by that destination.

### Task Object and Pipeline Details

A Task object is composed of one or more Work objects—usually just one, but if the time to process the work is small (i.e. the document is short), then several Work objects may be put in a Task object to keep the networking overhead down to a reasonable portion of the elapsed time.

A Work object is composed of a SourceDocument object and a Pipeline object.

A SourceDocument object is composed of a character String identifying the document (sufficient to retrieve the document, typically a URL), and methods to return a few simple properties of the document (size, data format, language, character set).

A Pipeline object is composed of an UIMA AnalysisEngineDescriptor object, which represents a configuration of a UIMA AnalysisEngine. This configuration object is typically generated by UIMA from an XML text file that the application developer has written and submitted to the TA Service as part of his processing request. The AnalysisEngineDescriptor object specifies the sequence of processors (UIMA Annotators) to run, what their input and outputs are, and values for their configuration parameters, such as paths to various data files (dictionaries, rule packages, etc.).

All of the code and configuration data for these Annotators is supplied by the application developer, and are not previously known to the TA Service. The TA Service is not specifically tied to the ThingFinder or the other Inxight libraries, but is rather a generic framework for running text analysis. The application developer must obtain these Annotators from outside the TA Service project (commercial, open-source, internal SAP, etc.), and submit them to the TA Service.

In the worker, the Pipeline starts a transaction with the Space and obtains a Task object from the task queue. For each Work object in the Task, it creates a UIMA AnalysisEngine from the AnalysisEngineDescriptor, thereby loading the code (Java classes) for each Annotator.

The worker will obtain the code for an Annotator by making a network connection to the application using the Java Remote Method Invocation (RMI) protocol. The worker JVM knows how to connect to the application because the JVM in the application has annotated the AnalysisEngineDescription object with a URL. The URL is transferred along with the AnalysisEngineDescription when the application JVM sends it to the TA Service JVM as part of the job request. In the worker JVM, this URL is inherited by objects related to the AnalysisEngineDescription, such as the AnalysisEngine, so that when it comes time to load the Java class specified in the AnalysisEngineDescription for a given Annotator, the worker JVM has the network address of the application JVM, from which to download the class. This is called “code mobility”, and is a feature of Java RMI.

With the AnalysisEngine created, the Pipeline creates a UIMA Common Analysis Structure (CAS), and puts the properties from the Work's SourceDocument object (primarily the document identifier) into the CAS, and starts the AnalysisEngine on the CAS.

The AnalysisEngine runs each Annotator in order. The first Annotator uses the document identifier from the CAS to download the document content. From there, other Annotators filter the document content into text, process the text through various analyses (identifying parts of speech, entities, key sentences, categorizing the document, and so on), each reading something from the CAS, and writing its results back to the CAS. At the end, the last Annotator writes all the accumulated data in the CAS to a database or back to the application. The Pipeline creates a Result object containing the document identifier, an indication of success or failure, the cause of the failure, and some performance metrics.

The worker repeats this for each Work in the Task, and then writes a combined Result object for all the Work in the Task back to the Task queue. Finally, the worker commits the transaction for the Task with the Space server.

### Pipeline Examples

As powerful and configurable as the text analysis technologies are, they are typically not sufficient by themselves to implement all the document processing that an application needs. Typically, an application developer must construct a sequence of document-level processing steps, augmenting the linguistic analysis and entity extraction for their use-case. We call these document processing steps processors, and a series of processors a pipeline. In an ETL tool, these are called transforms and data flows, but for our purposes here, we choose the neutral terms processor and pipeline. We call the ability for an application developer to add his own code to the pipeline, to make decisions as a document progresses through the pipeline about what comes next and how it is called, “custom linguistic pipelines”, or CLP.

To illustrate the need for a pipeline infrastructure that applications can extend, these are some examples of an almost endless number of processors that customers could want to use on documents: property mapping (e.g. the mapping of “creator” to “author”); query matching and relevance scoring; geo-tagging (including 3rd party tools by MetaCarta, Esri, etc.); topic detection; topic clustering or document clustering; gazetteer; thesaurus lookups; and location disambiguation.

Typically, in order to fulfill the requirements of its domain, an application will need to do some sort of custom document processing before or after the SAP text analysis libraries, integrate in processors from other parties (commercial or open source), or make decisions during the pipeline based on results so far (such as what to run next, how to configure it, or which data resources to use).

For example, the particular sense of an ambiguous term (e.g., “bank”: financial institution or river edge?) or entity (e.g., “ADP”: metabolic molecule or payroll company?) can more accurately be guessed if the software has some sense of the general domain being discussed in the local context. This could be done by running Categorizer™ to establish a domain (i.e., a subject code) from the blend of vocabulary in a passage of text, and then using that information to select a dictionary for entity extraction.

In the following sub-sections, we attempt to demonstrate the need for an extensible pipeline by describing some use cases for custom linguistic processing.

CLP Use Case 1: News Article (Unstructured, Short). Process the article first with Categorizer™ using a news taxonomy. Coding might include both industry and event codes.

Next, process the article with ThingFinder™ using industry-appropriate name catalogs (e.g., petrochemical) and/or event-appropriate custom groupers (e.g., mergers and acquisition articles get processed with an M&A fact grouper, etc.)

We might also process news article datelines with a dateline grouper, for example:

BEIJING, March 16 (Xinhuanet)—Blah blah blah

TEL AVIV, Israel—March 12/PRNewswire-Firstcall/—Blah blah blah

CLP Use Case 2: News Article (Unstructured, Longer). Same as above, except segment the document in pieces and do each part separately. This might yield better results in longer articles. We will need some heuristics to determine segment boundaries. Also, we need to consider the consequences of segmented documents on entity aliasing.

CLP Use Case 3: Top News of the Day (or Hour). Most news outlets periodically produce articles that have several totally unrelated parts. These parts range from just a headline, to a headline and summary, to a headline and full (though usually brief) article. Each part should be processed separately. Even though the items might be nothing more than headlines, categorization and entity/fact extraction can still be run on those headlines, and should be run on them individually rather than as a single article.

CLP Use Case 4: News Article (XML). Process the document in logical pieces, whether all title and body text as one unit or segmented. However, non-prose information (e.g., tables of numbers, like commodities prices) can either be skipped altogether, or can be specifically diverted to an appropriate table extractor (custom grouper). Source-provided metadata can also be leveraged in the processing. For example, if the source is Journal of Petroleum Extraction and Refining, certain assumptions can be made about the domain and therefore used to select name catalogs and/or groupers. Some articles might come with editorially applied keywords or category codes which could also be leveraged. In general, the customer should be able to retain source-provided metadata, by mapping it to the output schema, but it is usually not desirable to treat this metadata as text when performing extraction.

CLP Use Case 5: Intelligence Message Traffic. Leverage source-provided subject codes, origin, etc. to select most appropriate name catalogs and fact packs. The regimen might include a call to an external Web service, e.g., to perform location disambiguation on the whole list of place-related entities and geo-codes. However, we should consider the implications of blocking the execution of a CLP for what might be a high-latency transaction.

CLP Use Case 6: Pubmed Abstract (XML). Pubmed abstracts are very structured. At the head are any number of metadata fields (e.g., source journal, date, ascension number, MeSH codes, author, etc.), followed by a title and then the abstract text. At the tail there is often a list of contributors and a bibliography of citations, for example:

Contributors:

Smith, A Z; Peterson, P F; Robert, A D

A CLP could easily use an XML parser (whether a Perl module or a Java class) to direct various pieces to prose-oriented processing or structure-specific groupers.

CLP Use Case 7: Patent Abstract (XML). Similar to the Pubmed case. There are either industry-defined or de facto standards, provided by the USPTO and/or vendors like MicroPatent.

CLP Use Case 8: Business Document (PDF, Word). First, the document will have to be converted to HTML. At that point, it has been lightly marked up in HTML. The document could be processed by individual paragraph, group of n adjacent paragraphs, page, section, etc.

### Pull Model Details

The embodiment of FIG. 3 is referred to as a “pull” model because documents are pulled from a source instead of passing through the application 108a or the TA system 104. This pull model is more efficient than the push model (described later).

The application client 108a submits the job to the Job Controller 306, giving a URL to (for example) a content management system (CMS), and a configuration of an Analysis Engine. This request is asynchronous, so the application 108a does not wait.

The controller 306 gathers the URL's from the CMS, creates Task objects around them, and writes the Tasks to the queue 304. The workers 302 take the Tasks and execute them, placing Status objects back in the queue 304. The controller 306 gets the Status objects from the queue 304, and if the client has installed a completion handler, it calls the handler for that URL. The handler may, for example, send an asynchronous event message back to the client so that it may track progress.

Depending on the application, the controller 306 may also record information about the completed URL in a Collection Status database 308, such as the modification date and the checksum, so that incremental updates may be implemented. That is, the next time the CMS system is processed, the system 104 can determine which documents have actually changed since the last time, and skip those that have not.

When the controller 306 has Status objects for all the Tasks, the job is complete, and the controller 306 sends an overall job Status message back to the client 108a.

### Push Model Details

An alternate embodiment implements a push model. In the push model, the TA system 104 receives the document content in the job request (for example, as a SOAP attachment). The job controller 306 will hold the text in memory and generate a unique URL for it. The job controller 306 will then create tasks for these HTTP URLs exactly as in the pull model. When the worker 302 retrieves the content using the URL it found in the task (using HTTP GET), the controller 306 responds with the content.

The workers 302 then send the results back using the same URLs (using HTTP PUT). The job controller 306 calls back to the application with each result.

In summary, internally the system 104 retains the pull model, but the job controller 306 provides an external interface that creates a bridge to the push model. Unfortunately, this may create a networking and CPU bottle-neck in the application 108a and/or the controller 306, and so the push model may not scale nearly as well as the pull model.

FIG. 7 is a block diagram of an example computer system and network 2400 for implementing embodiments of the present invention. Computer system 2410 includes a bus 2405 or other communication mechanism for communicating information, and a processor 2401 coupled with bus 2405 for processing information. Computer system 2410 also includes a memory 2402 coupled to bus 2405 for storing information and instructions to be executed by processor 2401, including information and instructions for performing the techniques described above. This memory may also be used for storing temporary variables or other intermediate information during execution of instructions to be executed by processor 2401. Possible implementations of this memory may be, but are not limited to, random access memory (RAM), read only memory (ROM), or both. A storage device 2403 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 2403 may include source code, binary code, or software files for performing the techniques or embodying the constructs above, for example.

Computer system 2410 may be coupled via bus 2405 to a display 2412, such as a cathode ray tube (CRT) or liquid crystal display (LCD), for displaying information to a computer user. An input device 2411 such as a keyboard and/or mouse is coupled to bus 2405 for communicating information and command selections from the user to processor 2401. The combination of these components allows the user to communicate with the system. In some systems, bus 2405 may be divided into multiple specialized buses.

Computer system 2410 also includes a network interface 2404 coupled with bus 2405. Network interface 2404 may provide two-way data communication between computer system 2410 and the local network 2420. The network interface 2404 may be a digital subscriber line (DSL) or a modem to provide data communication connection over a telephone line, for example. Another example of the network interface is a local area network (LAN) card to provide a data communication connection to a compatible LAN. Wireless links is also another example. In any such implementation, network interface 2404 sends and receives electrical, electromagnetic, or optical signals that carry digital data streams representing various types of information.

Computer system 2410 can send and receive information, including messages or other interface actions, through the network interface 2404 to the local network 2420, the local network 2421, an Intranet, or the Internet 2430. In the network example, software components or services may reside on multiple different computer systems 2410 or servers 2431, 2432, 2433, 2434 and 2435 across the network. A server 2435 may transmit actions or messages from one component, through Internet 2430, local network 2421, local network 2420, and network interface 2404 to a component on computer system 2410.

The computer system and network 2400 may be configured in a client server manner. For example, the computer system 2410 may implement a server. The client 2415 may include components similar to those of the computer system 2410.

More specifically, the computer system and network 2400 may be used to implement the system 100, or more specifically the text analysis cluster 104 (see FIG. 3). For example, the client 2415 may implement the application client 108a. The server 2431 may implement the document source 102. The server 2432 may implement the job controller 306. The server 2433 may implement the task queue 304. The server 2434 may implement the repository 106. Multiple computer systems 2410 may implement the workers 302.

Embodiments of the present invention may be contrasted with existing solutions in one or more of the following ways.

In contrast to the Inxight Processing Manager™ tool, in an embodiment of the present invention, a pipeline processes a document completely in memory (of the worker), with no network I/O between the steps, achieving near 100% CPU utilization. Further, the system can scale to any number of machines, and uses the network very efficiently, creating no bottlenecks. If a text analysis library crashes a worker, the system automatically recovers and continues processing the request, achieving a high degree of system availability. The system provides fair and concurrent service to any number of clients.

In contrast to the Inxight Text Services Platform™ tool, an embodiment of the present invention is many times more efficient. The ceiling for a given network speed is about five times that of TSP (estimate), and the hardware cost for a target net system throughput is about a third that of TSP. The on-going operational cost of the system is also much lower, as one does not have to pay humans to manually re-configure the machines for different clients, or watch for failures and manually recover. The development costs for the application teams are much lower in the TA Service (e.g., as implemented by the TA System 104) because it provides a pipeline framework that does not exist in TSP.

In contrast to the Apache UIMA Asynchronous Scale-Out™ tool, the TA Service may serve many clients with different configurations, and can do so without disrupting service. Code may be transferred from the application to the TA Service as needed, and dynamically loaded. The Job Controller provides task priorities and fair servicing of tasks between clients. The TA System may recover from a machine failure and restart processing of any disrupted documents.

In contrast with Hadoop™, the TA Service separates the coordination information for the job from the bulk of the data (documents and results), so there is a minimum of network I/O, and no disk I/O.

In summary, the TA Service may be differentiated from other existing systems in one or more of the following ways. First, the distributed producer-consumer queue has not previously been used to scale document processing. This networked master-worker pattern has the consumer/producer queue at the center and workers distributed over many machines (also referred to as the space-based architecture). Workers pull tasks (tasks are not pushed to them), so no load-balancing is required. CPU utilization is naturally, and always, very high over the entire set of machines, regardless of system configuration or the data being processed. No manual configuration is necessary, greatly reducing operational costs. Also, using transactions with the space makes the system reliable (fault-tolerant, no data loss).

Second, code download into a document processing service is new. Multiple application clients, each with their own pipeline (code, data, configuration), run concurrently. The system need not know about the code when it was built—code is downloaded at run-time. The system does not have to be restarted in order to support a new application. The system provides fair allocation of resources to the clients' jobs. Multiple tenants sharing hardware lowers capital costs.

Third, the separation on the network of control data from data to be processed (i.e. the documents) and the result data is new. Separating on the network the control data from the bulk document content and result data, allows optimum usage of network bandwidth and no bottle-necks, resulting in maximum scalability and efficiency, to hundreds of CPU cores. There need be no disk I/O to slow the system down (as in Hadoop). Compared to other solutions, the TA System uses a smaller number of less-expensive machines, greatly lowering capital costs.

In addition, the combination of the three is unique to the problem of document processing and text analysis, and results in system qualities of scalability, efficiency, reliability, and multi-tenancy that cannot be matched by any existing document processing system.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer implemented method of processing documents, comprising:
generating, by a controller system, a text analysis task object, wherein the text analysis task object includes instructions regarding a document processing pipeline and a document identifier;
storing the text analysis task object in a task queue as one of a plurality of text analysis task objects;
accessing, by a worker system of a plurality of worker systems, the text analysis task object in the task queue;
generating, by the worker system, the document processing pipeline according to the instructions in the text analysis task object;
performing text analysis, by the worker system using the document processing pipeline, on a document identified by the document identifier; and
outputting, by the worker system, a result of performing text analysis on the document.

2. The computer implemented method of claim 1, further comprising:
generating, by the controller system, the plurality of text analysis task objects;
storing the plurality of text analysis task objects in the task queue; and
accessing, by at least some of the plurality of worker systems according to a first-in, first-out priority, the plurality of text analysis task objects.

3. The computer implemented method of claim 1, further comprising:
generating, by the controller system, the plurality of text analysis task objects;
storing the plurality of text analysis task objects in the task queue;
receiving, by the controller system, a plurality of requests from at least some of the plurality of worker systems; and
providing, by the controller system, the plurality of text analysis task objects to the at least some of the plurality of worker systems according to a first-in, first-out priority.

4. The computer implemented method of claim 1, wherein accessing the text analysis task object in the task queue comprises accessing, by the worker system via a first network path, the text analysis task object in the task queue, further comprising:
accessing, by the worker system via a second network path, the document identified by the document identifier.

5. The computer implemented method of claim 1, wherein accessing the text analysis task object in the task queue comprises accessing, by the worker system via a first network path, the text analysis task object in the task queue, further comprising:
accessing, by the worker system via a second network path, the document identified by the document identifier,
wherein outputting the result comprises outputting, by the worker system via a third network path, the result of performing the text analysis on the document.

6. The computer implemented method of claim 1, wherein the worker system encounters a failure when performing the text analysis and fails to output the result, further comprising:
replacing, by the controller system, the text analysis task object in the task queue after a time out; and
accessing, by another worker system of the plurality of worker systems, the text analysis task object having been replaced in the task queue.

7. The computer implemented method of claim 1, wherein the document processing pipeline includes a plurality of document processing plug-ins arranged in an order according to the instructions.

8. The computer implemented method of claim 1, wherein the document processing pipeline includes a first document processing plug-in and a second document processing plug-in arranged in an order according to the instructions, further comprising:
performing text analysis, by the worker system using the first document processing plug-in, on the document to generate an intermediate result; and
performing text analysis, by the worker system using the second document processing plug-in, on the intermediate result to generate the result of performing text analysis on the document.

9. The computer implemented method of claim 1, wherein the document processing pipeline includes a first document processing plug-in and a second document processing plug-in arranged in an order according to the instructions, further comprising:
performing text analysis, by the worker system using the first document processing plug-in, on the document to generate an intermediate result; and
performing text analysis, by the worker system using the second document processing plug-in as configured by the intermediate result, on the document to generate the result of performing text analysis on the document.

10. The computer implemented method of claim 1, wherein the document processing pipeline includes a first document processing plug-in and a second document processing plug-in arranged in an order according to the instructions, further comprising:
performing text analysis, by the worker system using the first document processing plug-in, on the document to generate a first intermediate result and a second intermediate result; and
performing text analysis, by the worker system using the second document processing plug-in as configured by the first intermediate result, on the second intermediate result to generate the result of performing text analysis on the document.

11. A system for processing documents, comprising:
a controller system that is configured to generate a text analysis task object, wherein the text analysis task object includes instructions regarding a document processing pipeline and a document identifier;
a storage system that is configured to implement a task queue, wherein the storage system is configured to store the text analysis task object in the task queue as one of a plurality of text analysis task objects; and
a plurality of worker systems, wherein a worker system is configured to access the text analysis task object in the task queue,
wherein the worker system is configured to generate the document processing pipeline according to the instructions in the text analysis task object,
wherein the worker system is configured to perform text analysis, using the document processing pipeline, on a document identified by the document identifier, and
wherein the worker system is configured to output a result of performing text analysis on the document.

12. The system of claim 11, wherein the controller system is configured to generate the plurality of text analysis task objects;
wherein the storage system is configured to store the plurality of text analysis task objects in the task queue; and
wherein at least some of the plurality of worker systems are configured to access, according to a first-in, first-out priority, the plurality of text analysis task objects.

13. The system of claim 11, wherein the controller system is configured to generate the plurality of text analysis task objects;
wherein the storage system is configured to store the plurality of text analysis task objects in the task queue;
wherein the controller system is configured to receive a plurality of requests from at least some of the plurality of worker systems; and
wherein the controller system is configured to provide the plurality of text analysis task objects to the at least some of the plurality of worker systems according to a first-in, first-out priority.

14. The system of claim 11, wherein the worker system is configured to access the text analysis task object in the task queue via a first network path; and
wherein the worker system is configured to accessing the document identified by the document identifier via a second network path.

15. The system of claim 11, wherein the worker system is configured to access the text analysis task object in the task queue via a first network path;
wherein the worker system is configured to accessing the document identified by the document identifier via a second network path; and
wherein the worker system is configured to output the result of performing the text analysis on the document via a third network path.

16. The system of claim 11, wherein the document processing pipeline includes a plurality of document processing plug-ins arranged in an order according to the instructions.

17. The system of claim 11, wherein the document processing pipeline includes a first document processing plug-in and a second document processing plug-in arranged in an order according to the instructions;
wherein the worker system is configured to perform text analysis using the first document processing plug-in on the document to generate an intermediate result; and
wherein the worker system is configured to perform text analysis using the second document processing plug-in on the intermediate result to generate the result of performing text analysis on the document.

18. The system of claim 11, wherein the document processing pipeline includes a first document processing plug-in and a second document processing plug-in arranged in an order according to the instructions;
wherein the worker system is configured to perform text analysis using the first document processing plug-in on the document to generate an intermediate result; and
wherein the worker system is configured to perform text analysis, using the second document processing plug-in as configured by the intermediate result, on the document to generate the result of performing text analysis on the document.

19. The system of claim 11, wherein the document processing pipeline includes a first document processing plug-in and a second document processing plug-in arranged in an order according to the instructions;
wherein the worker system is configured to perform text analysis using the first document processing plug-in on the document to generate a first intermediate result and a second intermediate result; and
wherein the worker system is configured to perform text analysis, using the second document processing plug-in as configured by the first intermediate result, on the second intermediate result to generate the result of performing text analysis on the document.

20. A non-transitory computer readable medium storing a computer program for controlling a document processing system to execute processing comprising:
a first generating component that controls a controller system to generate a text analysis task object, wherein the text analysis task object includes instructions regarding a document processing pipeline and a document identifier;
a storing component that controls the controller system to store the text analysis task object as one of a plurality of text analysis task objects in a task queue;
an accessing component that controls a worker system of a plurality of worker systems to access the text analysis task object in the task queue;
a second generating component that controls the worker system to generate the document processing pipeline according to the instructions in the text analysis task object;
a text analysis component that controls the worker system to perform text analysis, using the document processing pipeline, on a document identified by the document identifier; and
an outputting component that controls the worker system to output a result of performing text analysis on the document.
